(19) United States
(12) Patent Application Publication
(10) Pub. No.: US 2008/0202235 A1
(43) Pub. Date: Aug. 28, 2008

(54) Sensor Assembly

(75) Inventors: Larry D. Laps, Canton, OH (US); Scott Warren, Dover, OH (US); Ernie Wanner, Massillon, OH (US); Robert D. Ringle, Canton, OH (US); Timothy J. Krabill, Louisville, OH (US); Greg Piotrowski, North Canton, OH (US)

Correspondence Address: POLSTER, LIEDER, WOODRUFF & LUCCHESI, 12412 POWERSCOURT DRIVE SUITE 200, ST. LOUIS, MO, 63131-3615, US

(73) Assignee: THE TIMKEN COMPANY, Canton, OH (US)

(21) Appl. No.: 11/996,163

(22) PCT Filed: Jul. 20, 2006
(86) PCT No.: PCT/US06/28421

§ 371 Date: Jan. 18, 2008

Related U.S. Application Data
(60) Provisional application No. 60/701,047, filed on Jul. 20, 2005.
(60) Provisional application No. 60/731,708, filed on Oct. 31, 2005.

(51) Int. Cl. G01D 11/24

(52) U.S. Cl. 73/431

(57) ABSTRACT

A sensor assembly. A sensor assembly 34 that has a sensing element 26 is mountable in a housing 5. The housing has an inner surface 12, an outer surface 14, a bore 16 disposed there through and further has a sensed object 24 positioned across a gap from the sensing element 26. The sensor assembly 34 comprises a sensor body 35 having a first portion 36 and a second portion 38, the first portion 36 and the second portion 38 being positioned within the bore 16. The second portion 38 positions the sensing element 26 at an end of the second portion 38. The sensor assembly 34 further comprises an anti-corrosion member 56 positioned within the bore 16. Additionally, the sensor assembly 34 comprises a retaining member 58 removably fastened to the first portion 36 wherein the retaining member 58 such that the anti-corrosion member 56 isolates the sensing element 26 from the outer surface 14 to prevent contaminants from contacting the sensing element 26.

### CROSS-REFERENCE TO RELATED APPLICATIONS

This application claims priority to U.S. Patent Nos. 60/701,047 and 60/731,708 filed Jul. 20, 2005 and Oct. 31, 2005 respectively and both applications are incorporated herein by reference.

### TECHNICAL FIELD

This invention relates in general to sensor assemblies and more particularly to a sensor assembly that is capable of eliminating corrosion on a sensor mounting surface and eliminates corrosion that affects a sensing element of the sensor assembly.

### BACKGROUND ART

For sensors mounted in metal housings, the interface between the sensor and housing is critical. The mounting/interface surface for the sensor is typically the reference surface that positions the sensor. As such, the mounting must be located properly and must be protected from corrosion throughout the expected life of the sensor. Corrosion between the sensor and mounting surface can cause the sensor to lift from the surface, affecting the gap between the sensor and target being monitored. The size and integrity of the gap between the sensor and target are quite important. Typically, the gap should be kept relatively small and within close tolerances for the sensor to function properly.

In order for corrosion to occur, there must be an electrochemical cell consisting of an anode, a cathode and conductive fluid or gas in contact with the anode and cathode. If even a small gap exists between the sensor and mounting surface and the gap allows a conductive fluid to get under the sensor, an accelerated type of corrosion called crevice corrosion can occur. Crevice corrosion can exert a significant upward force against the sensor, causing it to lift from the surface. Therefore protection of the mounting surface from corrosion is critical to proper sensor operation. One application where sensors are mounted on steel in severe environments is automotive wheel bearings. For these applications, the sensor mounting surface must be protected against the effects of water, saltwater and vehicle fluids under a range of temperatures and other environmental conditions.

In addition, protection of the sensor bore is critical for serviceability of the sensor. If the sensor bore is not protected, a ring of corrosion will build up within the bore, making it impossible to remove the sensor.

Applications today use various methods to protect the sensor mounting surface, the primary means being the application of grease between the sensor and mounting surface. However, testing has shown that under severe corrosion conditions, the grease can be washed out, resulting in reduced performance. Other applications such as those described in U.S. Pat. Nos. 5,085,519, 5,123,755 and 5,192,138 use O-ring seals around the sensor. These applications, however, expose the mounting surface of the sensor to the environment.

The foregoing and other objects, features, and advantages of the disclosure as well as presently preferred embodiments thereof will become more apparent from the reading of the following description in connection with the accompanying drawings.

### BRIEF DESCRIPTION OF THE DRAWINGS

In the accompanying drawings which form part of the specification:

FIG. 1 is a sectional view of a portion of a sensor assembly constructed in accordance with and embodying the present disclosure showing: the sensor assembly mounted in a sleeve having a seal between the sleeve inner diameter and sensor outer diameter, with the sleeve mounted in a housing bore; a sensor shoulder of the sensor assembly seated against a reference mounting surface of the housing bore and a retaining member fastened to the sensor assembly and applying a seating force to the sensor assembly;

FIG. 2 is a perspective view of an embodiment of a sensor body of the sensor assembly of FIG. 1;

FIG. 3 is a perspective view of an embodiment of the retaining member of the sensor assembly of FIG. 1;

FIG. 4 is a breakaway sectional view of a portion of another sensor assembly constructed in accordance with and embodying the present disclosure showing the sensor assembly being inserted into a housing;

FIG. 5 is a sectional view of a portion of the sensor assembly of FIG. 4 showing the sensor assembly mounted in the housing, wherein the sensor assembly mounts in a bore of the housing, while a threaded fitting applies a seating force to the sensor assembly and further showing a seal mounted at a top of the bore to prevent contaminant ingress into the bore;

FIG. 6 is a sectional view of a portion of another sensor assembly constructed in accordance with and embodying the present disclosure showing: a sensor assembly mounted in a bore of a housing having a counterbore to accept a seal, with a sensor shoulder of the sensor assembly seated against a reference mounting surface in the bore; and another retaining member of the present disclosure attached to the housing to apply a seating force to the sensor assembly;

FIG. 7 is a sectional view of a portion of another sensor assembly having a sleeve and a retaining member, constructed in accordance with and embodying the present disclosure, showing: the sensor assembly mounted in the sleeve having a seal between the sleeve inner diameter and an outer diameter of the sensor assembly, with the sleeve mounted in a housing bore and the retaining member connected to the sleeve; the sensor assembly having a flanged end and an anti-rotation member wherein the anti-rotation member contacts the sleeve;

FIG. 8 is a perspective view of an embodiment of the retaining member of FIG. 7 contacting the flanged end;

FIG. 9 is a perspective view of the sleeve of FIG. 7;

FIG. 10 is a side view of the sleeve of FIG. 9;

FIG. 11 is a perspective view of the retaining member of FIG. 7 contacting the flanged end;

FIG. 12 is a front elevational view of the retaining member of FIG. 11 contacting the flanged end and sleeve;

FIG. 13 is a sectional view of a portion of another sensor assembly having a sleeve and a retaining member, constructed in accordance with and embodying the present disclosure, showing: the sensor assembly mounted in the sleeve having a seal between the sleeve inner diameter and an outer diameter of the sensor assembly, with the sleeve mounted in a housing bore; the sensor assembly having a flanged end wherein the retaining member contacts the flanged end and the sleeve;

FIG. 14 is a perspective view of an embodiment of the retaining member engaging the flanged end;

FIG. 15 is a perspective view of a sensor body and retaining member of the sensor assembly of FIGS. 13 and 14;

FIG. 16 is a plan view of the sensor body the sensor assembly of FIG. 15;

FIG. 17 is a perspective view of the retaining member of FIG. 13;

FIG. 18 is a plan view of the retaining member of FIG. 17; and

FIG. 19 is a sectional view along line “19-19” of FIG. 18.

Corresponding reference numerals indicate corresponding parts throughout the several figures of the drawings.

### BEST MODES FOR CARRYING OUT THE INVENTION

The following detailed description illustrates the disclosure by way of example and not by way of limitation. The description clearly enables one skilled in the art to make and use the disclosure, describes several embodiments, adaptations, variations, alternatives, and uses of the disclosure, including what is presently believed to be the best mode of carrying out the disclosure.

The disclosure relates to an assembly having a sensor system that produces an output signal while preventing corrosion build-up in a sensor mounting surface. The sensor assembly of the present disclosure may relate to a variety of technologies. For example, the sensor may monitor a variety variables relating to an object to produce an output signal for the monitored variables. These variables may include but are not limited to speed, load, temperature or vibration. In all applications, the sensor assembly interacts with a housing to prevent corrosion build-up on the sensor mounting surface.

For illustrative purposes, the following description illustrates the sensor assembly monitoring a speed variable. One application of this disclosure may relate to automotive wheel bearings, that is to say a wheel end, where a speed sensor of the present disclosure mounts within a housing, projecting into the bearing wherein the sensor detects the speed of a rotating component.

A bearing assembly may couple a road wheel to the suspension system of an automotive vehicle, particularly to a component of the suspension system, such as a steering knuckle and enables the wheel to rotate about an axis of rotation, which is, of course, the axis of the bearing assembly. Aside from coupling the wheel to a component of the suspension system, the bearing assembly further generates an electrical signal, which is responsive to the rotation of the wheel and, indeed, represents the angular velocity at which the wheel revolves about the axis. This enables a controller in an antilock brake system or traction control system to monitor the angular velocity of the wheel.

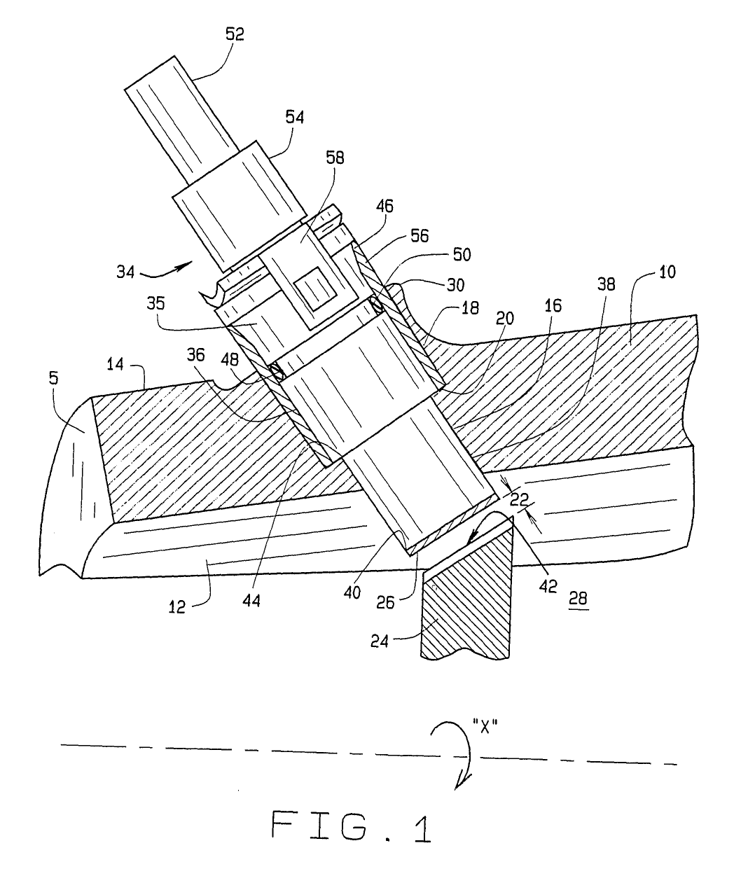

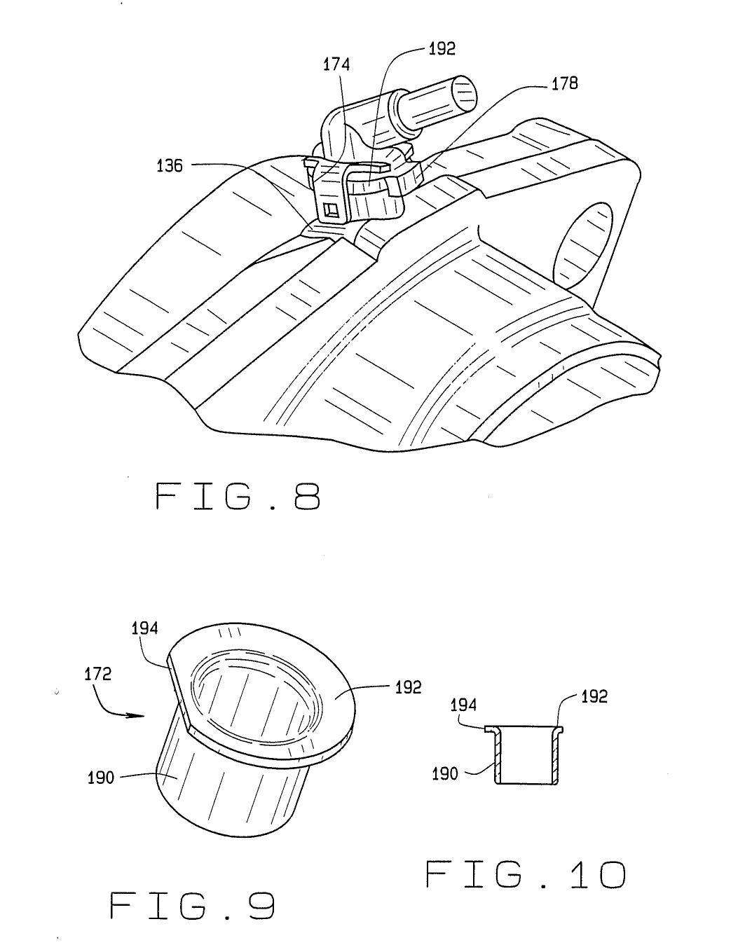

A sensor assembly is removably mountable within a housing 5 (FIG. 1). The housing 5 which may include a bearing assembly that includes an outer race 10 having a generally cylindrical external surface, wherein the outer race 10 may be stationary relative to a rotating shaft (not shown). In an embodiment, the housing 5 may be incorporated into a suspension system (such as the system partially shown in FIG. 8) wherein the housing defines an axis “X” of rotation there through. The outer race 10 has an inner surface 12 and an outer surface 14. Between the inner and outer surfaces 12 and 14, a bore 16 is disposed there through, wherein the bore 16 includes a counterbore 18. The counterbore 18 has a larger diameter than the bore 16 to form a reference-mounting surface 20 of the interface of the bore 16 and the counterbore 18. The reference mounting surface 20 may be dimensioned within the bore 16 to properly set a gap 22 between a sensed object 24 and a sensing element 26. In this illustrative example, the sensed object 24 may comprise a target wheel. The sensor object 24 along with its operative surface cooperates with the sensing element 26 to produce a pulsating signal when inner race rotates within the outer race, with the frequency of the signal reflecting the angular velocity.

In an embodiment, the bore 16 and counterbore 18 may angle obliquely within the housing 5. In other embodiments, the bore 16 and counterbore 18 may configure at any angle within the housing 5. The bore 16 opens into the interior 28 of the housing 5 while the counterbore 18 opens out of the outer surface 14. The bore 16 and counterbore 18 may lie within the thickest portion of the outer race 10 and indeed exist not only in the region between the inner and outer surfaces 12,14, but also within a boss 30 that projects from the generally cylindrical outer surface 14 of the outer race 10.

The bearing assembly associated with housing 5 further comprises an inner race (not shown). The bearing, while permitting the shaft to rotate about the axis “X” of rotation, confines the shaft radially and axially within the housing 5. In other words, the bearing transfers radial loads between the shaft and the housing 5 and also thrust loads in axial directions. The bearing includes the inner race in the form of a cone, the outer race 10 in the form of a cup and rolling elements (not shown) in the form of rollers. The inner race has an inner raceway that may incline with respect to the axis “X” of rotation, and the outer race 10 has an outer raceway that may incline with respect to the axis “X” of rotation.

The rolling elements are located between and contact the inner race and the outer race. The rolling elements are confined within cages, which distribute the rolling elements uniformly and thereby maintain the proper spacing between the rolling elements. The cages also retain the rolling elements around the inner race when the inner race is withdrawn from the housing/outer race. The rolling elements transmit thrust and radial loads between the outer racer and the inner race, while reducing friction to a minimum.

A sensor assembly, generally shown as 34, of the present disclosure removably mounts within the housing 5 (FIG. 1). The sensor assembly 34 comprises a sensor body 35, which includes a first portion 36 and a second portion 38. The first portion 36 is positioned within the bore 16 and partially extends beyond the outer surface 12 of the housing 5 while the second portion 38 is positioned within the bore 16. The sensor assembly 34 positions the sensing element 26 at an inner end 40 of the second portion 38. Furthermore, the second portion 38 may position the sensing element 26 at an angle opposite an operative surface 42 of the sensed object 24.

The first portion 36 may have a larger diameter than a diameter of the second portion 38 to form a sensor shoulder 44 at the interface of the first portion 36 and the second portion 38. The sensor shoulder 44 contacts the reference mounting surface 20 when the sensor body 35 mounts within the housing 5. When the sensor shoulder 44 contacts the reference mounting surface 20, the first portion 36 positions within the counterbore 18 while the second portion 38 positions within the bore 16. As such, these portions of the sensor assembly 34 are contained within the housing 5.

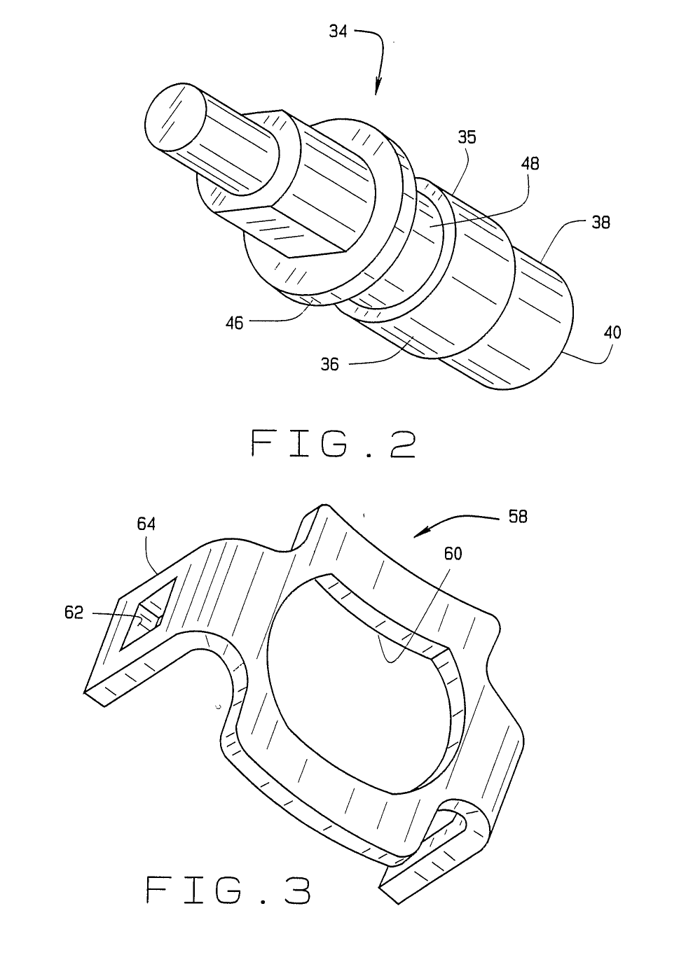

The sensor assembly 34 also comprises a flanged end 46 that radially extends outward from the first portion 36 and over portions of the outer surface 14. Further, the first portion 36 includes an annular groove 48 (FIGS. 1-2). The annular groove 48 is located between the flanged end 46 and the inner end 40 of the second portion 38. That is to say, the annular groove 48 is positioned within the first portion 36 that fits within the counterbore 18. A seal 50 (FIG. 1) is radially positioned within the annular groove 48 such that the seal 50 isolates the first portion 36 and the second portion 38 of the sensor assembly 34 from the outer surface 14 of the housing 5. The seal 50 also isolates the first portion 36 and the second portion 38 from the boss 30. This isolation by the seal 50 prevents contaminants from contacting the first and second portions 36,38 and reference mounting surface 20 (FIG. 1). In an embodiment, the seal 50 may comprise an O-ring.

The sensor assembly 34 further comprises a flexible electrical conduit 52 emerging from a suitable grommet 54, which prevents ingress of contaminants into the other components of the sensor assembly 34. FIG. 2 shows a perspective view of the sensor assembly 34 and illustrates the sensor body 35, first portion 36, second portion 38, flanged end 46 and annular groove 48.

Returning to FIG. 1, the sensor assembly 34 further comprises an anti-corrosion member 56 in the form of a sleeve. The anti-corrosion member 56 is positioned within the bore 16 and partially extending beyond the outer surface 14 of the housing 5 while contacting the sensor body 35. As shown, the anti-corrosion member/sleeve 56 surrounds a portion of the first portion 36, annular groove 48 and seal 50. As such, the seal 50 is positioned between the inner diameter of the seal sleeve 56 and the outer diameter of the first portion 36. As shown, the sleeve 56 press fits within the counterbore 18. The sleeve 56 must be properly oriented during installation such that an end of the sleeve contacts the reference mounting surface 20. The sleeve 56 may comprise any suitable material such as but not limited to plastic, steel or brass.

The sensor assembly 34 additionally comprises a retaining member 58 (FIG. 1). The retaining member 58 removably fastens to the first portion 36 and contacts the anti-corrosion member 56. The retaining member 58 retains the anti-corrosion member 56 against the first portion 36 of the sensor body 35 such that the anti-corrosion member 58 isolates the sensing element 26 from the outer surface 12 to prevent contaminants from contacting the sensing element 26. In particular, the retaining member 58 removably fastens to the flanged end 46 of the sensor assembly 34. The retaining member 58 also contacts the anti-corrosion member 56 in order to properly orientate the sensing element 26 in the bore 16. The retaining member 58 may comprise a means for attaching to the anti-corrosion member 56 such that the sensing element 26 is properly oriented rotationally in the bore 16. In an embodiment, the retaining member 58 may comprise a fastener in the form of a spring clip.

FIG. 3 shows an embodiment of the retaining member 58 comprising at least one side portion 64 that has a center aperture 60 defined there through that aligns with the sensor assembly 34 (FIG. 1). Apertures 62 in side portions 64 of the retaining member 58 may align with projections on the anti-corrosion member 56. In another embodiment, another option to provide sensor retention and orientation is to have a lip around the perimeter of the top portion of the anti-corrosion member 56, with the lip having a flat side. In this embodiment, the retaining member 58 aligns with the flats on the anti-corrosion member 56 and clips over the lip.

The sensor assembly 34 of FIGS. 1-3 results in the sensor mounting surface 20 being positioned below the seal 50 and therefore eliminates corrosion on the sensor mounting surface 20. Additionally, this sensor assembly 34 eliminates the need for machining of the sensor pad and simplifies the sensor design by eliminating a sensor attachment flange. Furthermore, this sensor assembly 34 eliminates a capscrew and tapped capscrew hole typically used in a wheel bearing application.

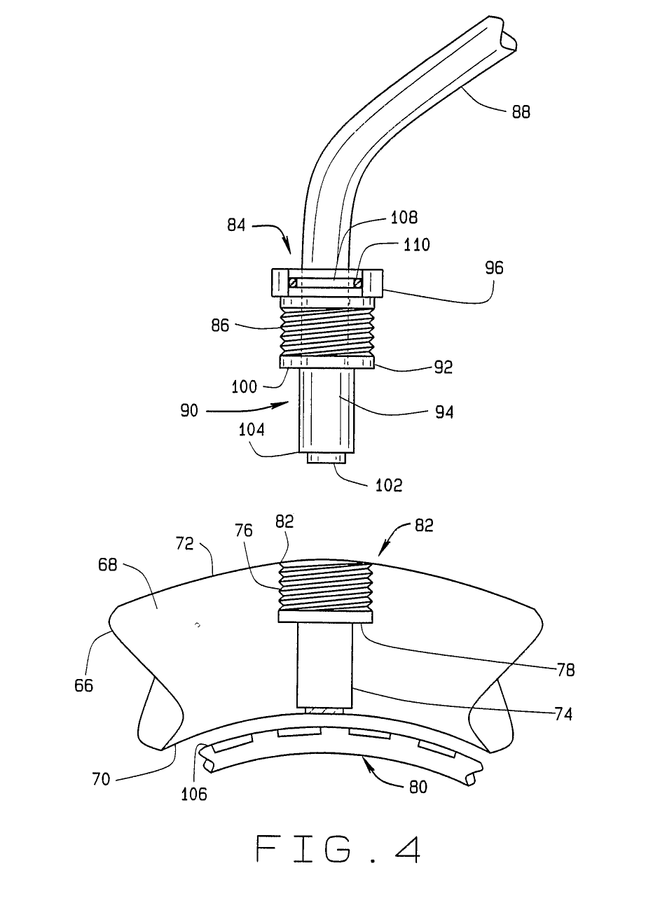

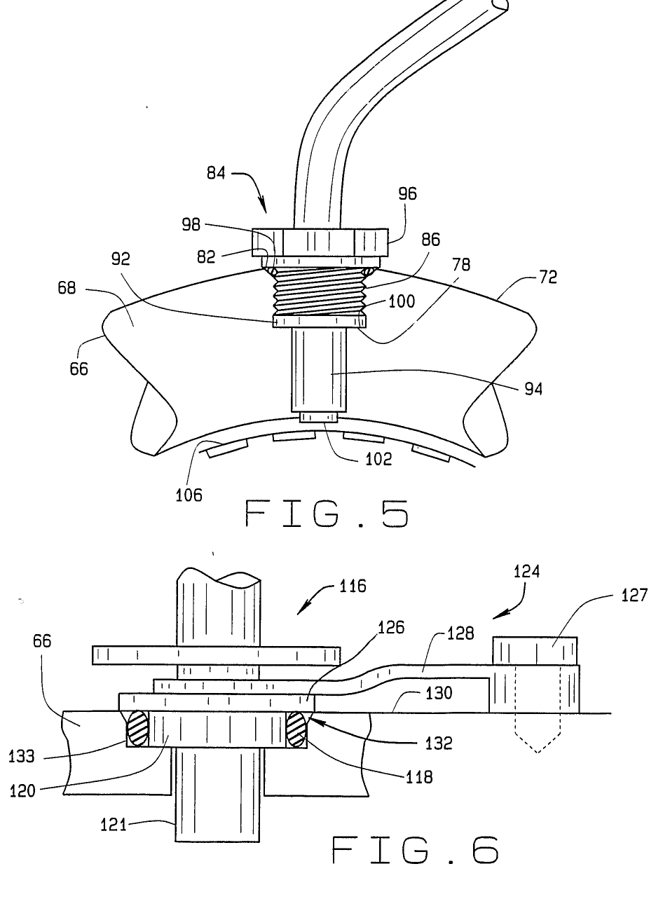

Turning to FIGS. 4 and 5, another embodiment of a sensor assembly of the present disclosure is shown. In this embodiment, the housing 66 which may include a bearing assembly that has an outer race 68 having a generally cylindrical external surface, wherein the outer race 68 may be stationary relative to the axis of rotation of a shaft (not shown). The housing 66 has an inner surface 70 and an outer surface 72. The inner and outer surfaces 70, 72 define a bore 74 there through. The bore 74 includes a threaded counterbore 76 as shown in FIG. 4. The counterbore 76 has a larger diameter than the bore 74 to form a reference mounting surface 78 within the housing 66. The reference mounting surface 78 may be dimensioned within the bore 74 to properly set the gap between a sensed object 80 and sensor.

The bore 74 and threaded counterbore 76 may angle perpendicularly within the housing 66 with respect to the sensed object 80. In other embodiments, the bore 74 and counterbore 76 may be configured at any angle within the housing 66. As shown, a chamfered surface 82 is located between the counterbore 76 and the outer surface 72. The bore 74 opens into the interior of the housing 66 while the counterbore 76 opens out of the outer surface 72 via the chamfered surface 82.

As shown in FIGS. 4 and 5, a sensor assembly, generally shown as 84, of the present disclosure removably connects with the housing 66. The sensor assembly 84 comprises a threaded fitting 86, a flexible electrical conduit 88 and a sensor body generally shown as 90 having a first portion 92, and a second portion 94. The threaded fitting 86 has an aperture defined there through and further comprises a flanged end 96, wherein the flanged end 96 extends outward from the fitting 86. The sensor assembly 84 further has a seal 98 (FIG. 1). The sensor first portion 92 comprises a flange having a larger diameter than a diameter of the second portion 94 to form a sensor shoulder 100 at the interface of the first portion 92 and second portion 94. As shown, the second portion 94 positions sensor 102 at an inner end 104.

During assembly, the electrical conduit 88 inserts within the aperture of the fitting 86 such that the inside diameter of the fitting aperture has a loose fit over the electrical conduit 88. The sensor body 90 is positioned within the bore 74 to position sensor shoulder 100 against the referenced mounting surface 78 (FIG. 5). The fitting 86 is threaded into the threaded counterbore 76 and contacts the flange of the first portion 92, compressing shoulder 100 against the mounting surface 78.

When the sensor shoulder 100 contacts the reference mounting surface 78, the threaded fitting 86 positions within the counterbore 76 while the sensor second portion 94 positions within the bore 74. As such, these portions of the sensor assembly 84 are contained within the housing 66. The fitting 86 provides a downward clamp force on the sensor shoulder 100. Furthermore, the sensor second portion 94 positions the sensor 102 opposite an operative surface 106 of the sensed object 80.

The seal 98 is radially positioned below the flanged end 96 such that when the fitting 86 is threaded into counterbore 76, the flanged end 96 provides a seating force against the seal 98. Now positioned within the bore, the seal 98 isolates the first portion 92 and the second portion 94 of the sensor assembly 84 from the outer surface 72 of the outer race 68. This isolation by the seal 98, in combination with contact between the bottom side of the threaded fitting 86 and the upper surface of the sensor shoulder 100, prevents contaminants from contacting the reference mounting surface 78. In an embodiment, the seal 98 may comprise an O-ring.

As shown in FIG. 4, the fitting 86 may include an annular groove 108. In one embodiment, the annular groove 108 may be located within the flanged end 96. A seal 110 is radially positioned within the annular groove 108 to further isolate the reference mounting surface 78 from contaminants such as a liquid that may “wick” down the sensor conduit 88. The sensor assembly of FIGS. 4-5 results in the sensor mounting surface 78 being positioned below the seal 98 and below the sealing interface between the fitting 86 and sensor shoulder 100 and therefore eliminates corrosion on the sensor mounting surface 78. Additionally, it eliminates any machining of the sensor pad and simplifies the sensor design by eliminating the sensor attachment flange. Furthermore, this bearing assembly eliminates a capscrew and tapped capscrew hole.

Turning to FIG. 6, another embodiment of the present disclosure is shown. This embodiment may incorporate the housing 66 of the embodiment of FIGS. 4-5. The sensor assembly, generally shown as 116, of this embodiment also comprises an anti-corrosion member 118 in the form of a seal. In this embodiment, the sensor assembly 116 comprises a first portion 120 and second portion 121. The first portion 120 may have a larger diameter than a diameter of the second portion 121 to form a sensor shoulder.

A retaining member 124 in the form of a fastener contacts with a flanged end 126 of sensor assembly 116. The retaining member 124 applies a seating force against the flanged end 126 to force the flanged end 126 toward outer surface 130 of the housing 66. In an embodiment, the retaining member 124 comprises a cap screw 127 and an arm member 128 such that the arm member 128 connects the cap screw 127 with the flanged end 126. The fastener 124 forces the flanged end 126 against anti-corrosion member 118 and compresses it against chamfered surface 132 of the housing 66. In an embodiment, the seal of the anti-corrosion member 118 may comprise an O-ring.

Additionally, the retaining member 124 compresses the seal 118 against a counterbore 133 such that the outside vertical surface of the seal 118 intersects the chamfered surface 132 in the counterbore 133. The chamfered surface 132 must be designed so that when corrosion occurs, the amount of corrosion will not prevent removal of the sensing element. That is to say the first portion 120 will not break the vertical plane of the counterbore 122.

The sensor assembly of FIG. 6 results in the sensor shoulder surface being positioned below the seal and therefore eliminates corrosion on the sensor mounting surface. Additionally, it provides sufficient clearance between the arm member 128 and the sensor mounting surface to eliminate effects of corrosion on the outer surface 130.

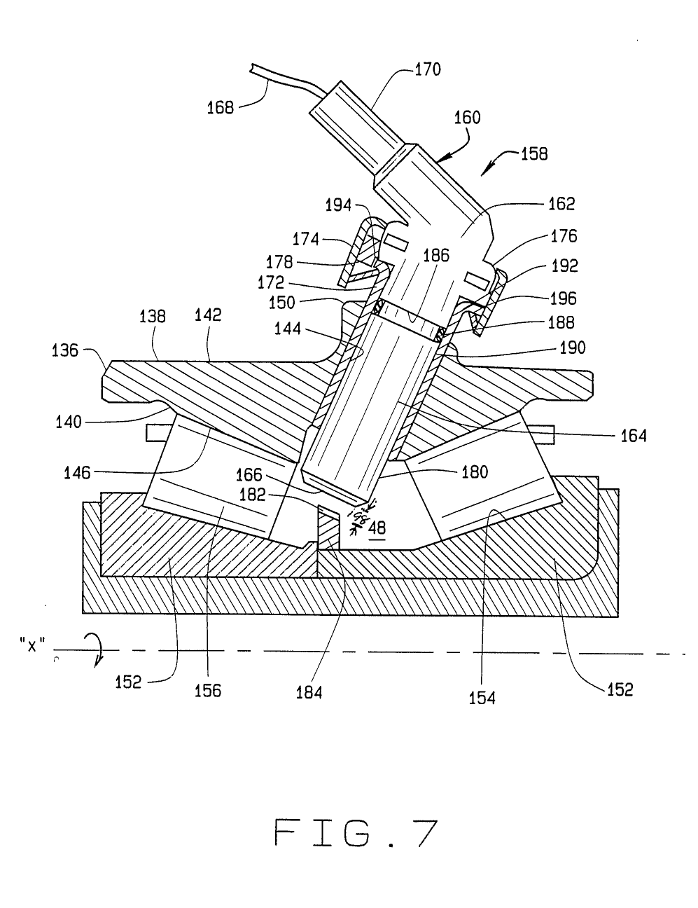

Turning to FIG. 7, another embodiment at the present disclosure is shown. As shown in FIG. 7, a housing 136 which may include a bearing assembly that includes outer race 138, in the form of cup, having a generally cylindrical external surface, wherein the outer race 138 may be stationary relative to a rotating shaft (not shown). In an embodiment, the housing 136 may be incorporated into a suspension system (such as the system partially shown in FIG. 8) that defines an axis of rotation there through.

The housing 136 has an inner surface 140 and an outer surface 142. The housing 136 between its inner and outer surfaces 140 and 142 contains a bore 144 there through. The outer race 138 has a pair of raceways 146, which face toward the axis “X” of rotation. In an embodiment, the bore 144 may angle obliquely within the housing 136. In other embodiments, the bore 144 may angle at any angle within the housing 136. The bore 144, at one end, opens into the interior 148 of the housing 136 while the bore 144, at another end, opens out of the outer surface 142. The bore 144 may lie within the thickest portion of the outer race 138 and indeed exist not only in the region between the inner and outer surfaces 140, 142, but also within a boss 150 that projects from the generally cylindrical outer surface 142 of the outer race 138.

The bearing assembly further comprises an inner race 152 in the form of a cone, which is rotatable relative to the outer race 138. The inner race 152 contains respective raceways 154. In addition to the raceways 154, the bearing assembly has a complement of rolling elements 156 in the form of rollers. The rolling elements 156 are located between and contact the inner race 152 and the outer race 138. The rolling elements 156 are confined within cages, which distribute the rolling element 156 uniformly in the row and thereby maintain the proper spacing between the rolling element 156. They also retain the rolling elements 156 around the inner race 152 when the inner race 152 is withdrawn from the outer race 138. The rolling elements 156 transmit thrust and radial loads between the outer race 138 and the inner race 152, while reducing friction to a minimum.

A sensor assembly, generally shown as 158, of the present disclosure removably mounts within the housing 136 (FIG. 7). The sensor assembly 158 comprises a sensor body 160, which has a first portion 162 and a second portion 164; a sensing element 166; conduit 168; a strain relief member 170; an anti-corrosion member 172 and a retaining member 174. The first portion 162 includes a flanged end 176 positioned outside the housing 136 wherein the flanged end 176 radially extends outward from the first portion 162 and over portions of the outer surface 142 of the housing 136. The first portion 162 is positioned within the bore 144 and partially extends beyond the outer surface 142 of the housing 136. The flanged end 176 has an anti-rotation member 178 downwardly extending from an end of the flanged end 176. The first portion 162 positions the flexible electrical conduit 168, which emerges from the strain relief member 170, outside of the housing 136 to prevent ingress of contaminants into components of the first portion 162.

The second portion 164 positions the sensing element 166 at an inner end 180. The inner end 180 is positioned opposite an operative surface 182 of a sensed object 184. In this illustrative example, the sensed object 184 may comprise a target wheel.

The first portion 162 further includes an annular groove 186 located between the flanged end 176 and the inner end 180 of the second portion 164. A seal 188 is radially positioned within the annular groove 186 such that the seal 188 isolates the second portion 164 of the sensor assembly 158 from the outer surface 142 of the housing 136. This isolation by the seal 188 prevents contaminants from contacting the second portion 164 and the sensing element 166. In an embodiment, the seal 188 may comprise an O-ring.

The anti-corrosion member 172 in the form of a sleeve comprises an annular body 190 having an outer lip 192 wherein the outer lip 192 includes a sleeve anti-rotation member 194 in the form of a flat side (FIGS. 9 and 10). The sleeve anti-rotation member 194, however, is not limited to a flat side but may comprise other retention means such as but not limited to a tab and a protrusion. The anti-corrosion member 172 is positioned within the bore 144 and extends partially beyond the outer surface 142 of the housing 136 (FIG. 7). As shown, the anti-corrosion member 172 further contacts the sensor body 160.

The anti-corrosion member 172 press fits partially within the bore 144 and extends partially beyond the outer surface 142 (FIG. 7). When press fit within the bore 144, a portion of the annular body 190 surrounds a portion of the first portion 162 and the annular groove 186. Additionally, a top of the outer lip 192 positions against a bottom of the flanged end 176 to form a sensor interface 196 between the top of the outer lip 192 and the bottom of the flanged end 176. The insertion of the anti-corrosion member 172 and the interface 196 between the flanged end 176 and the outer lip 192 controls a gap 198 between the sensing element 166 and the operating surface 182 of the sensed object 184. When inserted into the bore 144, the anti-corrosion member 172 also prevents ingress of contaminants within the bore 144. Furthermore, the seal 188 is positioned between the inner diameter of the anti-corrosion member 172 and the outer diameter of the second portion 164 to further assist prevention of contamination ingress. The anti-corrosion member 172 may comprise any suitable material such as but not limited to plastic, steel or brass.

When press fit into the bore 144, the anti-corrosion member 172 positions the outer lip 192 and associated sleeve anti-rotation member 194 outside of the housing 136 (FIG. 7). As noted, the outer lip 192 abuts the bottom of the flanged end 176 of the first portion 162 such that the sleeve anti-rotation member 194 abuts the anti-rotation member 178 of the flanged end 176. In this configuration, the second portion 164 cannot rotate within the bore 144 since the sleeve anti-rotation member 194 and the anti-rotation member 178 prohibit movement of the second portion 164.

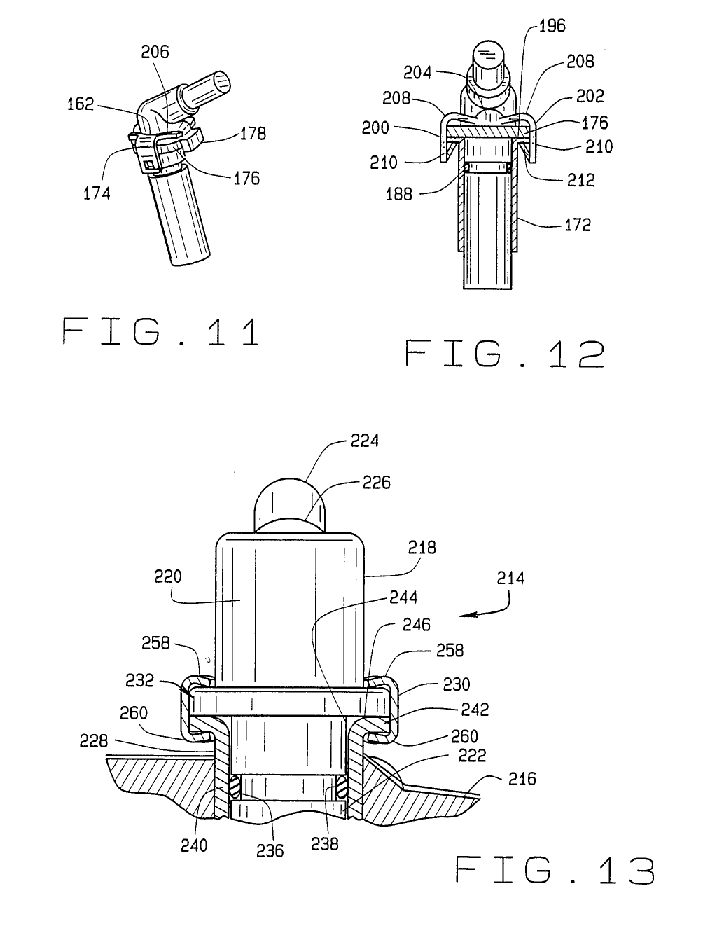

The retaining member 174 (FIGS. 7, 8, 11 and 12) comprises a first side member 200, a second side member 202, a back member 204 and a channel 206. The retaining member 174 removeably fasters to the first portion 162 and contacts the anti-corrosion member 172. The retaining member 174 retains the anti-corrosion member 172 against the first portion 162 such that the anti-corrosion member 174 isolates the sensing element 166 from the outer surface to prevent contaminants from contacting the sensing element 166. The back member 204 spaces apart the first side member 200 and second side member 202. As such, the channel 206 is disposed within the first side member 200, the second side member 202 and the back member 204. The channel 206 allows convenient insertion of the retaining member 174 from the top side of the first portion 162. As shown in FIG. 11, the channel 206 is configured to position around a portion of the first portion 162 at a location adjacent to and on top of the flanged end 176.

Each first side member 200 and second side member 202 has a curved portion 208, a leg portion 210 and a bias member 212 (FIG. 12). The curved portion 208 extends outwardly from the back member 204 and around the flanged end 176. The leg portions 210 extend downwardly from the curved portions 208 and beyond the flanged end 176. The bias members 212 upwardly extend at an angle from the leg portions 210. The bias members 212 contact a bottom of the outer lip 192 of the anti-corrosion member 172 at a position opposite the flanged end 176 wherein the bias members 212 retain the anti-corrosion member 172 against the flanged end 176 (FIGS. 7 and 12). In this position, the retaining member also retains the anti-rotation member of the flanged end 176 against the sleeve anti-rotation member 194.

The bias members 212 contact the anti-corrosion member 172 to provide retention of the sensor assembly 158 within the bore 144. The bias members 212 retain the flanged end 176 against the outer lip 192 of the anti-corrosion member 172 to provide sensor retention within the anti-corrosion member 172. Furthermore, when the anti-rotation member 178 aligns against the sleeve anti-rotation member 194, the bias members 212 maintain the orientation of the second portion 164 within the bore 144. Due to the bias members 212, the retaining member 174 maintains a tight fit between the flanged end 176 and the outer lip 192 of the anti-corrosion member 172 to prevent ingress of contaminants between the outer lip 192 and the flanged end 176.

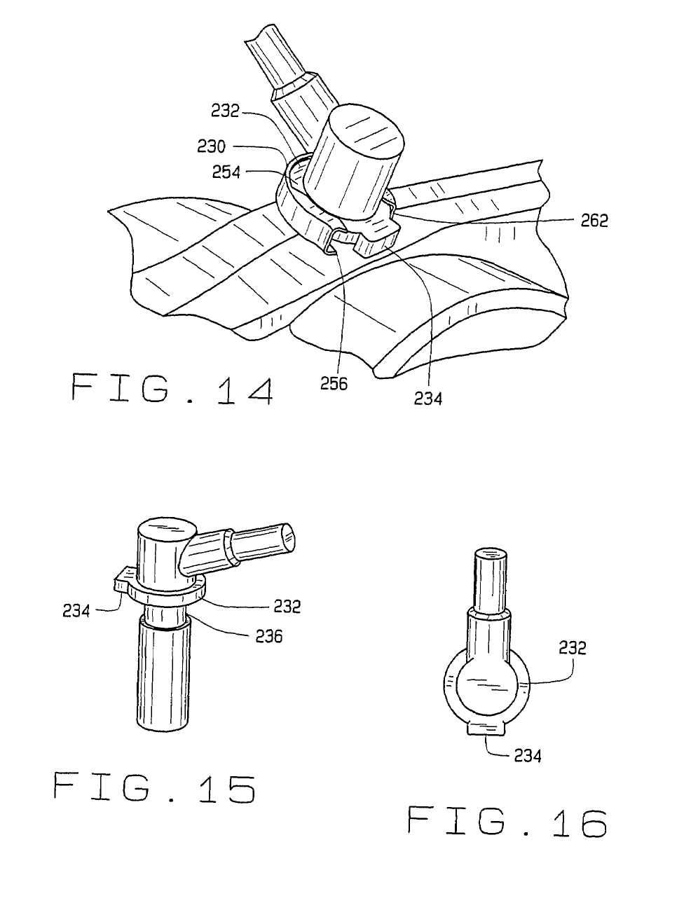

FIGS. 13-19 illustrate another embodiment of a sensor assembly, generally shown as 214, of the present disclosure. In this embodiment, the sensor assembly 214 removably mounts within housing 216, which is similar to housing 136 disclosed in FIG. 7. As shown in FIG. 13, the sensor assembly 214 comprises a sensor body 218, which includes a first portion 220 and a second portion 222; a sensing element (not shown); conduit 224; a strain relief member 226; a corrosion resistant sleeve 228 and a retaining member 230. The first portion 220 is positioned within the bore and partially extends beyond the outer surface at the housing 216. The first portion 220 includes a flanged end 232 (FIGS. 13, 14 and 15) positioned outside the housing 216 that radically extends outward from the first portion 220 and over portions of the outer surface of the housing 216. The flanged end 232 has an anti-rotation member 234 (FIGS. 14-16) extending from an end of the flanged end 232. The first portion 220 positions the flexible electrical conduit 224, which emerges from the strain relief member 226, outside of the housing 216 to prevent ingress of contaminants into components of the first portion 220. The second portion 222 positions the sensing element at an inner end (not shown). The inner end is positioned opposite an operative surface (not shown) of a sensed object (not shown) as previously discussed.

The first portion 220 further includes an annular groove 236 located between the flanged end 232 and the inner end of the second portion 222. A seal 238 is radially positioned within the annular groove 236 such that the seal 238 isolates the second portion 222 of the sensor assembly 214 from the outer surface of the housing 216. This isolation by the seal 238 prevents contaminants from contacting the second portion 222 and the sensing element. In an embodiment, the seal 238 may comprise an O-ring.

The anti-corrosion member 228 (FIG. 13) in the form of a sleeve comprises an annular body 240 having an outer lip 242. The outer lip 242 may include a sleeve anti-rotation member (not shown) in the form of a flat side as previously discussed. This sleeve anti-rotation member, however, is not limited to a flat side but may comprise other retention means such as but not limited to a tab and a protrusion. The anti-corrosion member 228 press fits partially within the 244 of the housing 216 and extends partially beyond the outer surface of the housing 216 to provide an interference fit between the annular body 240 and the bore 244. The anti-corrosion member 228 prevents ingress of contaminants within the bore 244. When press fit within the bore 244, a portion of the annular body 240 surrounds a portion of the second portion 222 and the annular groove 236. Additionally, a top of the outer lip 242 positions against a bottom of the flanged end 232 to form a sensor interface 246 between the top of the outer lip 242 and the bottom of flanged end 232. The insertion of the anti-corrosion member 228 and the interface 246 between the flanged end 232 and outer lip 242 controls the gap between the sensing element and the operating surface of the sensed object as previously discussed. Furthermore, the seal 238 is positioned between the inner diameter of the anti-corrosion member 228 and the outer diameter of the second portion 222 to further assist prevention of contamination ingress. The anti-corrosion member 228 may comprise any suitable material such as but not limited to plastic, steel or brass.

When press fit into the bore 244, the anti-corrosion member 228 positions the outer lip 242 outside of the housing 216 (FIG. 13). As shown, the outer lip 242 abuts the bottom of the flanged end 232 of the first portion 220. As previously discussed, the sleeve anti-rotation member of the outer lip 242 abuts against the anti-rotation member 234. In this configuration, the second portion 222 cannot rotate within the bore 244 since the sleeve anti-rotation member and the anti-rotation member 234 prohibits movement of the second portion 222.

The retaining member 230 (FIGS. 13-14, 17-19) comprises a first side member 248, a second side member 250, a back member 252 and a channel 254. The back member 252 spaces apart the first side member 248 and second side member 250. As such, the channel 254 is disposed within the first side member 248, the second side member 250 and the back member 252. The channel 254 allows convenient insertion of the retaining member 230 from the side of the first portion 220. As shown in FIG. 14, the channel 254 is configured to position around a portion of the first portion 220 (FIG. 13) at a location adjacent to and on top of the flanged end 232.

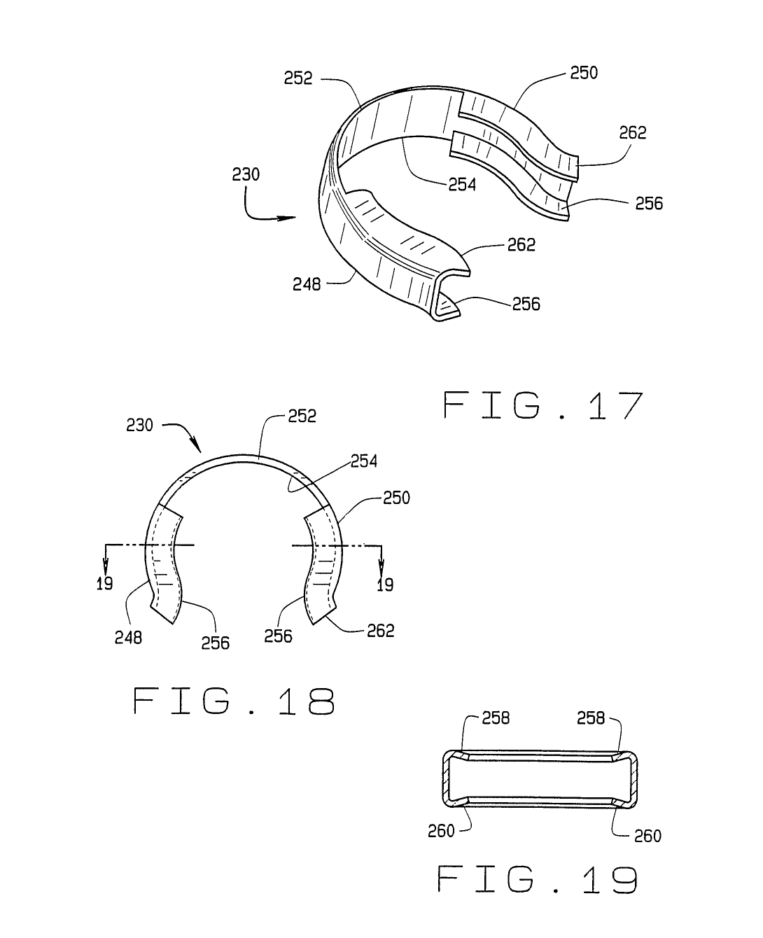

Each first side member 248 and second side member 250 has a curved channel 256 (FIGS. 17 and 18). Each curved channel 256 extends from the respective members 248, 250 and into the channel 254. Additionally, each curved channel 256 includes an upper bias member 258 and a lower bias member 260 (FIG. 19). The upper bias member 258 contacts the top of the flanged end 232 while the lower bias member 260 contacts the bottom of the outer lip 242 of the anti-corrosion member 228 (FIG. 13). When fully assembled, the curved channel 256 engages with the outer diameter of the flanged end 232 (FIG. 14). The curved channels 256 further include flared ends 262 (FIGS. 14, 17 and 18). The flared ends 262 allow the user to easily insert the retaining member 230 to engage the retaining member 230 with the anti-corrosion member 228 and the flanged end 232. In this position, the retaining member 230 also retains the anti-rotation member of the flanged end against the sleeve anti-rotation member.

The bias members 260 contact the anti-corrosion member 228 to provide retention of the sleeve assembly 214 within the bore 244 (FIG. 13). Further, as shown, the bias members 258 retain the flanged end 232 against the outer lip 242 of the anti-corrosion member 228 to provide sensor retention within the anti-corrosion member 228. Furthermore, when the anti-rotation member 234 aligns against the sleeve anti-rotation member of the sleeve anti-corrosion member 228, the bias members 258, 260 maintain the orientation of the second portion 222 within the bore 244. Due to the bias members 258, 260, the retaining member 230 maintains a tight fit between the flanged end 232 and the outer lip 242 of the anti-corrosion member 228 to prevent ingress of contaminants between the outer lip 242 and the flanged end 232.

The sensor assemblies of FIGS. 1-19 eliminate corrosion on the reference sensor interface. Additionally, these sensor assemblies eliminate the need for machining of any sensor pad and simplify the sensor design by eliminating any attachment flange. In the embodiments, the present disclosure provides sensors, which are robust against environmental effects such as corrosion and are easily serviceable. The sensor reference interface between the sensor portion and the sleeve is robust to corrosion or other environmental effects. The disclosure provides various means for attaching the sensor assembly to the particular housing, means for controlling the position of the sensing element relative to the sensed object and means for preventing contamination ingress to bearings. Furthermore, as previously mentioned, the sensor assembly of the present disclosure may be used for a variety of sensor technologies. For illustrative purposes, the sensor assembly was shown with a bearing arrangement wherein the sensor assembly may be used with all bearing types such as but not limited to tapered roller bearings, double row bearings, and indeed on other types of antifriction bearings such as but not limited to plain ball bearings, angular contact ball bearings, spherical roller bearings, angular contact bearings and cylindrical roller bearings.

In view of the above, it will be seen that the several objects of the disclosure are achieved and other advantageous results are obtained. As various changes could be made in the above constructions without departing from the scope of the disclosure, it is intended that all matter contained in the above description or shown in the accompanying drawings shall be interpreted as illustrative and not in a limiting sense.

1. A sensor assembly that has a sensing element mountable in a housing, the housing having an inner surface, an outer surface, a bore disposed there through and having a sensed object positioned across a gap from the sensing element, the sensor assembly, comprising:
a sensor body having a first portion and a second portion, the first portion and second portion being positioned within the bore, the second portion positioning the sensing element at an end of the second portion;
an anti-corrosion member positioned within the bore to isolate the second portion from the outer surface; and
a retaining member removably fastened to the sensor body to apply a force to the anti-corrosion member such that the anti-corrosion member isolates the sensing element from the outer surface to prevent contaminants from contacting the sensing element.

2. The sensor assembly of claim 1 wherein the retaining member is in contact with the anti-corrosion member such that the retaining member retains the anti-corrosion member against the sensor body.

3. The sensor assembly of claim 1 wherein the bore of the housing includes a counterbore such that an interface of the counterbore and the bore forms a reference mounting surface within the housing and wherein an outer diameter of the first portion of the sensor body is larger than an outer diameter of the second portion of the sensor body to form a sensor shoulder at the interface of the first portion and the second portion such that the sensor shoulder contacts the reference mounting surface when the sensor body mounts within the housing.

4. The sensor assembly of claim 1 wherein the first portion includes an annular groove and includes a seal positioned within the annular groove such that the seal isolates the second portion from the outer surface of the housing to prevent contaminants from contacting the second portion.

5. The sensor assembly of claim 4 wherein the anti-corrosion member comprises a sleeve that partially extends beyond the outer surface of the housing while being in contact with the sensor body.

6. The sensor assembly of claim 5 wherein the sleeve surrounds the seal.

7. The sensor assembly of claim 1 further comprising a flanged end that radially extends outward from the first portion and over portions of the outer surface.

8. The sensor assembly of claim 7 wherein the retaining member comprises at least one side portion, the side portion having an aperture defined there through wherein the aperture removably engages with the flanged end of the first portion.

9. The sensor assembly of claim 7 wherein the flanged end includes an anti-rotation member extending toward the outer surface of the housing.

10. The sensor assembly of claim 9 wherein the anti-corrosion member comprises a sleeve having an annular body, an outer lip and a sleeve anti-rotation member.

11. The sensor assembly of claim 10 wherein the annular body of the sleeve is positioned partially within the bore and extending partially beyond the outer surface to position a top of the outer lip against a bottom of the flanged end to form an interface between the top of the outer lip and the bottom of the flanged end such that the gap between the sensing element and an operating surface of the sensed object is controlled by the positioning of the sleeve within the bore and the positioning of the resultant interface between the outer lip and the flanged end.

12. The sensor assembly of claim 11 wherein the retaining member retains the outer lip against the bottom of the flanged end such that the anti-rotation member of the flanged end contacts the sleeve anti-rotation member.

13. The sensor assembly of claim 12 wherein the retaining member has curved portions, legs extending from the curved portions and bias members extending from the legs.

14. The sensor assembly of claim 13 wherein the curved portions and legs contact the flanged end and the bias members engage a bottom of the outer lip wherein the bias members retain the sleeve against the flanged end.

15. The sensor assembly of claim 12 wherein the retaining member has curved channels, each curved channel having an upper bias member and a lower bias member wherein the upper bias member engages a top of the flanged end and the lower bias member engages a bottom of the outer lip of the sleeve such that the bias members retain the sleeve against the flanged end.

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. A sensor assembly mountable in a housing, the housing having an inner surface, an outer surface, a bore disposed there through, the bore includes a counterbore such that an interface of the counterbore and the bore forms a reference mounting surface within the housing and the housing having a sensed object positioned across a gap from the sensing element, the sensor assembly, comprising:
a sensor body having a first portion and a second portion, the first portion being positioned within the bore and the second portion being positioned within the bore, wherein an outer diameter of the first portion of the sensor body is larger than an outer diameter of the second portion of the sensor body to form a sensor shoulder at the interface of the first portion and the second portion such that the sensor shoulder contacts the reference mounting surface when the sensor body mounts within the housing; and
an anti-corrosion member positioned within the counterbore, the anti-corrosion member further being in contact with the sensor body such that the anti-corrosion member isolates the second portion from the outer surface of the housing to prevent contaminants from contacting the second portion.

34. The sensor assembly of claim 33 further comprising a flanged end that radially extends outward from the first portion and over portions of the outer surface.

35. The sensor assembly of claim 34 further comprising a retaining member removably fastened to the flanged end wherein the retaining member retains the flanged end against the outer surface of the housing.
